(19) United States
(12) Patent Application Publication
(10) Pub. No.: US 2012/0174671 A1
(43) Pub. Date: Jul. 12, 2012

(54) METHOD FOR DETERMINING AND/OR MONITORING AT LEAST ONE PHYSICAL, PROCESS VARIABLE

(75) Inventor: Martin Urban, Lorrach (DE)

(73) Assignee: Endress + Hauser GmbH + Co. KG, Maulburg (DE)

(21) Appl. No.: 13/496,525

(22) PCT Filed: Aug. 17, 2010
(86) PCT No.: PCT/EP2010/061957

§ 371 Date: Mar. 16, 2012

(30) Foreign Application Priority Data
Sep. 30, 2009 (DE) 10 2009 045 204.4

(51) Int. Cl. G01N 29/00

(52) U.S. Cl. 73/579

(57) ABSTRACT

A method for determining and/or monitoring at least one physical, process variable of a medium with an oscillatable unit, wherein a transmitting/receiving unit excites the oscillatable unit by means of transmission signals to execute oscillations. The oscillations of the oscillatable unit are received in the form of received signals, and the process variable is determined and/or monitored based on the frequency and/or the amplitude of the received signal and/or phase shift between the transmission and the received signals. The time behavior of the amplitude of the received signal is examined and evaluated as a function of a time variation of the exciting of the oscillatable unit, and is determined therefrom whether accretion has formed on the oscillatable unit.

The present invention relates to a method for determining and/or monitoring at least one physical, process variable of a medium with an oscillatable unit, wherein a transmitting/receiving unit by means of transmission signals excites the oscillatable unit to execute oscillations, wherein the oscillations of the oscillatable unit are received in the form of received signals, and wherein the process variable is determined and/or monitored based on frequency and/or amplitude of the received signal and/or phase shift between transmission and received signals.

The process variable is, for example, fill level of a medium in a container, density, or viscosity of a liquid. The apparatus, with which the process variable is determined or monitored, is a vibronic measuring device, wherein the oscillatable unit is embodied preferably as a membrane, an oscillatory fork or a single rod.

The main use of vibronic measuring devices is for fill level measurement of liquids in containers. For detection of the reaching of a predetermined fill level, the effect of oscillation damping is utilized. The measuring device contains an oscillatable unit, most often, in the form a two tine, oscillatory fork, which is arranged on a membrane, which is excited to execute oscillations with the resonance frequency. Known, however, are also oscillatable units in the form of an oscillatable rod or a membrane without elements arranged supplementally thereon. A subceeding of, or falling beneath, a predetermined fill level can be recognized by the feature that the oscillation is no longer damped by the medium. Conversely, the reaching of a predetermined maximal fill level can be recognized by the feature that the oscillation is damped, as soon as the oscillatable unit is oscillating no longer in air, but, instead in the medium.

As a rule, the fill level of the fill medium recedes after a certain time and the oscillatable unit then oscillates freely again. This temporary covering of the oscillatable unit with the liquid can lead to residues on the oscillatable unit. Such accretions arise especially when the fill medium involves a viscous liquid, such as mustard or yogurt. If such deposits form on the oscillatable unit, this corrupts the measuring, since the oscillation frequency decreases because of the extra mass which is then being moved. The process variable is then no longer reliably determinable, for example, because the accreted measuring device no longer detects when the oscillatable unit is oscillating out of the medium. Therefore, it is desirable to develop information on whether the measuring device is free of accretion and delivering reliable measured values.

Known from the state of the art for accretion detection are methods for detecting changes in the oscillation frequency of the oscillatable unit. Thus, DE 10014724A1 teaches a method, in which a change of the mass of the oscillatable unit is recognized by evaluating at least two oscillation modes, which are preferably influenced differently by the medium. This method is disadvantageous, on the one hand, because two completely decoupled oscillation modes must exist, and, on the other hand, that these must be processed electronically, which places high requirements on the electronics.

Known from DE 10328296 A1 is a method, in which a limit value for the oscillation frequency is established as a function of the process conditions. Subceeding, or falling beneath, this limit value is equated to accretion formation. A disadvantage of this method is that the limit value must be newly determined for each medium, and variable factors, such as temperature, influence the limit value. Furthermore, in the case of application of the apparatus for detecting a maximal fill level, the limit value is also subceeded when the medium rises and covers the oscillatable unit, so that, in the case of gradual covering, without other measures, it is difficult to distinguish between accretion and covering because the medium has risen.

An object of the invention is to provide a method for determining and/or monitoring a process variable with an oscillatable unit, which method enables, moreover, the detection of accretion on the oscillatable unit.

The object is achieved by the features that time behavior of amplitude of the received signal is examined and evaluated as a function of a time variation of the exciting of the oscillatable unit, and that it is determined therefrom, whether accretion has formed on the oscillatable unit.

Time variation of the exciting means, for example, an interruption of the exciting or a changing of the excitation frequency.

The method is suited especially for accretion detection in the case of fill-level measuring devices, which utilize so-called MAX-operation, i.e. for overflow protection. In the case of this application, the oscillatable unit oscillates most of the time via in air, until the medium reaches the predetermined fill level. In air, the oscillation occurs undamped, so that the decay behavior of the oscillatable unit can be examined by considering the lessening amplitude of the received signal especially easily after an exciting. In the case of oscillation in the medium, the oscillation decays because of the damping significantly faster, so that an investigation of the decay behavior is difficult in such case. Additionally, it must be distinguished, whether the faster decaying of the oscillation is alone due to the medium or supplementally affected by accretion. For overcoming this problem, an option is that, at start-up of the measuring device or already in the plant, for determined media, a calibration measurement is performed, in which the decay behavior is recorded after the exciting of the accretion free, oscillatable unit. This calibration measurement can serve as a reference for later measuring, in the case of which accretion is possibly located on the oscillatable unit.

A first embodiment of the solution of the invention provides that the oscillatable unit is excited by means of a frequency sweep within a predetermined frequency band in the working range of the oscillatable unit by means of transmission signals successively to execute oscillations with discrete exciter frequencies following one after the other, wherein the oscillatable unit has a resonance frequency fRES, and wherein at least one of the exciter frequencies lies within a narrow interval around the resonance frequency fRES, and that the received signal is evaluated relative to modulations, which occur in the received signal in the form of local maxima and minima, wherein the local maxima of the received signal are detected, which occur when the decaying oscillation with the exciter frequency lying in the narrow interval around the resonance frequency fRES superimposes constructively with oscillations at frequencies following in the sweep and wherein, as a function of the number and/or height of the detected local maxima, it is detected, whether accretion has formed on the oscillatable unit.

In an advantageous embodiment, there is ascertained by the sweep an oscillation frequency, in the case of which a predetermined phase shift Δφ is present between transmission signal and received signal.

An advantageous method for exciting the oscillatable unit includes that the feature that the oscillatable unit is excited to execute oscillations with discrete excitation frequencies within a frequency sweep. In an embodiment, during the frequency sweep, that oscillation frequency is sought, in the case of which a predetermined phase shift Δφ occurs between transmission signal and received signal. Preferably, the predetermined phase shift Δφ=90°, so that the eigenfrequency of the oscillatable unit is ascertained by the frequency sweep. The received signal is evaluated relative to its amplitude in such a manner that that frequency is determined, in the case of which the predetermined phase shift Δφ is present and the received signal shows a global maximum, thus the amplitude is maximum. An especially advantageous method for evaluating the amplitude is described in a yet unpublished patent application (DE 102009028022) of the assignee. In the there disclosed method, the received signal is phase selectively sampled, so that occurring maxima are more clearly brought out and, additionally, the calculative effort is lessened.

In an alternative embodiment, the received signal is evaluated not with reference to the phase shift between transmission signal and received signal, but, instead, the frequency sweep is performed only for evaluation relative to accretion.

In the received signal of a frequency sweep, there are, besides a global maximum, other local maxima present. In the case of a frequency sweep for ascertaining a frequency, in the case of which a predetermined phase shift Δφ between received signal and transmission signal is present, the global maximum arises in the case of the frequency to be ascertained. If the frequency sweep is performed only for accretion detection via the arising local maxima and the received signal is correspondingly not processed relative to phase shift, the global maximum arises in the received signal at a frequency, which lies in a narrow interval around the resonance frequency. The local maxima belong to modulations, which follow the global maximum in time. In the case of exciting the oscillatable unit by the frequency sweep, it is excited, among other things, also with its resonance frequency fRES or a frequency near the resonance frequency fRES lying in a narrow interval around the same. The resonance frequency fRES is dependent on boundary conditions, such as, for example, the degree of the damping, with which the oscillations of the oscillatable unit are damped. In the special case of an undamped oscillation, the resonance frequency fRES agrees with the exciter frequency to be ascertained. By exciting the oscillatable unit with the resonance frequency fRES or a frequency near the resonance frequency fRES, energy is stored in the oscillatable unit. This enables the occurrence of modulations, which arise because of the superpositioning of the decaying oscillation with the resonance frequency fRES or a frequency near the resonance frequency fRES with oscillations with frequencies following in time in the frequency sweep.

In the case of damping accretion on the oscillatable unit, the oscillation is damped, which is reflected in a weakening of the modulations and, thus, also the local maxima. The number and height of the local maxima represents, thus, a measure of accretion formed on the oscillatable unit. The advantage in the case of this evaluation method compared with determining the frequency, at which a predetermined phase shift is present between transmission signal and received signal is that no additional measuring for accretion detection needs to be performed, but, instead the received signal is only examined as regards additional features. Subsequent frequency sweeps, as well as the determining of the process variable, can occur in parallel, unimpaired by the accretion detection.

In a further development of the method of the invention, a phase selective signal is produced from the received signal and the maxima of the phase selective signal detected. The termninology, phase selective signal, means, in such case, that the signal only contains selected values corresponding to the predetermined phase shift Δφ. If the predetermined phase shift is, for example, 90°, the received signal is sampled only at those points in time possessing a signal extrema and/or zero intercepts shifted 90° relative to the transmission signal. These sampling points are suitably taken into consideration and form the phase selective signal. If the received signal has said 90° phase shift, with this method, its extrema and zero intercepts are detected and suitably evaluated. If the phase shift of the received signal deviates from such specification, points of the received signal are detected, which do not coincide with the extrema or zero intercepts. The mentioned modulations occur also in the phase selective signal.

In the case of an additional further development of the invention, the received signal is evaluated relative to the decay constant of the exponential function resulting from the type of excitation and it is detected, as a function of the change of the decay constant over a defined period of time, whether accretion has formed on the oscillatable unit. In spite of the arising modulations, is the exponential decline of the amplitude of the received signal can still be detected in the form of the envelope. For example, by a curve fitting procedure, the exponential function corresponding to the decay behavior can be found and the decay constant determined.

A further development of the method of the invention provides that a threshold Ulimit of the received signal or of the phase selective signal is established, which is exceeded by a global maximum at a point in time t1 and subceeded at a later point in time t2, wherein the global maximum occurs at a frequency, which lies within the narrow interval around the resonance frequency fRES, and/or at which the predetermined phase shift Δφ is present, and wherein the point in time t2 of the subceeding, or falling beneath, the threshold Ulimit establishes the end of the global maximum. The threshold Ulimit is to be selected such that the noise floor lies below such and the exceeding of the threshold Ulimit, can thus be associated unequivocally with the occurrence of a maximum.

In a further development of the method of the invention, it is provided that the number of the local maxima arising in the received signal or in the phase selective signal is determined, wherein a local maximum is defined by the feature that the threshold Ulimit is exceeded at a point in time t3 lying behind the point in time t2, which determines the end of the global maximum, and subceeded at a later point in time t4, that a minimum number of local maxima is established, which must be present, when the oscillatable unit has no accretion, and that, through comparison of the arising number of local maxima with the minimum number, it is determined, whether accretion has formed on the oscillatable unit. For example, a reference measurement of the undamped oscillatable unit can be performed at start-up of the measuring device, in the case of which the occurring number of local maxima is determined. If this number decreases during measurement operation or if the local maxima even disappear completely, then it can be concluded that accretion is present.

A further development of the solution of the invention provides that the variance of the voltage values of the received signal or of the phase selective signal, which lie after the point in time t2, which determines the end of the global maximum, is ascertained, that a threshold value for the variance is fixed, which is at least reached, when the oscillatable unit is free of accretion and that, through comparison of the value determined for the variance with the threshold value, it is determined, whether accretion has formed on the, oscillatable unit. The variance is higher, the higher the local maxima. A low variance is, consequently, associated with little maxima, which, in turn, is the result of accretion formation.

Another further development of the invention provides that the oscillatable unit has a resonance frequency fRES, that the exciting of the oscillatable unit is done with a frequency lying in a narrow interval around the resonance frequency fRES or with a frequency, at which there is a predetermined phase shift Δφ between transmission signal and received signal, that the exciting is interrupted for a short time, that the received signal is evaluated relative to the decay constant of the exponential function resulting from the interruption of the exciting, and that it is established as a function of the decay constant, whether accretion has formed on the oscillatable unit.

The exciting of the oscillatable unit occurs in this embodiment either with the resonance frequency, or a frequency, which is near the resonance frequency, or with the frequency, at which a predetermined phase shift Δφ is present between transmission signal and received signal. For example, this frequency is tuned automatically by specification of phase shift Δφ via an oscillatory circuit. The resonance frequency is determined, for example, through recording the received signal and determining the maximal amplitude.

In order to be able to examine the decay behavior of the oscillatable unit via the received signal, the exciting must be interrupted for a short time. Short time means, in this case, only so long until the received signal shows a noticeable decline, for example, to 10% of the maximum value, so that the decay constant can be determined unequivocally. Then, the excitation can be continued. The intervals, in which the excitation is interrupted and the decay constant determined, are, in such case, preferably matched to the process.

In an advantageous embodiment of the invention, the predetermined phase shift amounts to 90°. If the oscillatable unit is excited in such a manner that the phase shift amounts to 90°, then it oscillates with the eigenfrequency. In the case of oscillation in air, the eigenfrequency equals the resonance frequency and, thus, in this way, the exciting with the resonance frequency is possible.

In a further development of the method of the invention, in case accretion has formed, an error report is produced and output and/or displayed. Especially, the error report is transmitted via a bus system to a control room, Alternatively or supplementally, the error report can be displayed in various ways, e.g. via a light-emitting diode, a signal tone, or on a display.

An advantageous embodiment of the method of the invention provides that, in the evaluation of the modulations, a number of limit values are predetermined for the number of local maxima or the variance, that, through comparison with the ascertained number of arising local maxima or with the ascertained variance, it is determined, how strongly the oscillatable unit is covered by accretion, and that a corresponding error report is produced and output and/or displayed. By the comparison with a plurality of limit values, there is, so to say, a gradation in accretion degrees. If the accretion degree is small, then there is no immediate danger that the process variable is determined incorrectly and a warning report in the form of an indication of a beginning accretion formation suffices. If the accretion degree is, in contrast, high, a pressing warning report can be output, which asks for quick replacement or cleaning of the measuring device. The different warning reports can appear, for example, on a display.

In an embodiment of the method of the invention, the time behavior of the amplitude of the received signal or of the phase selective signal is evaluated in the case of oscillation of the oscillatable unit in air. For oscillation in air, the oscillatable unit experiences almost no damping, so that damping accretion is well detectable.

Another embodiment includes that the time behavior of the amplitude of the received signal or of the phase selective signal is evaluated in the case of oscillation of the oscillatable unit in the medium and that, for this, a calibration measurement is done in the medium, in which the behavior without accretion on the oscillatable unit is determined. Evaluation in the case of oscillation in the medium is made difficult by the fact that the medium damps. In order to be able to examine the decay behavior with reference to accretion formation, an option, therefore, includes, for example, a reference measurement at start-up of the measuring device, for determining the influence of the damping medium on the oscillation. Accretion formation can then be ascertained from deviations in this behavior indicating extra damping.

In a further development of the solution of the invention, the oscillatable unit is a membrane, a membrane with an oscillatory fork or an oscillatory rod. An apparatus for performing a method of the invention includes a vibronic measuring device, with which, for example, the fill level, the density, or the viscosity of a liquid is determined. Vibronic fill level measuring devices with oscillatory forks for measurements in liquids are available from the assignee under the mark “Liquiphant”.

The invention will now be explained in greater detail based on the appended drawing, the figures of which show as follows:

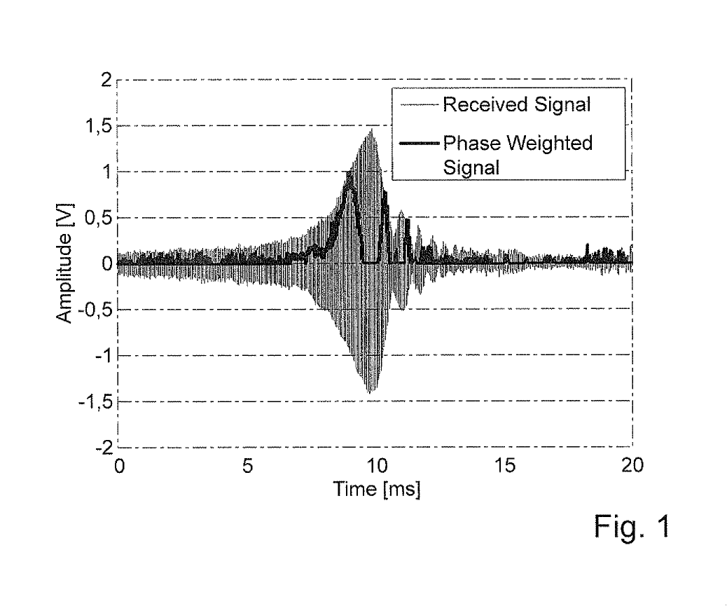

FIG. 1 the received signal with modulations in the case of exciting with a sweep;

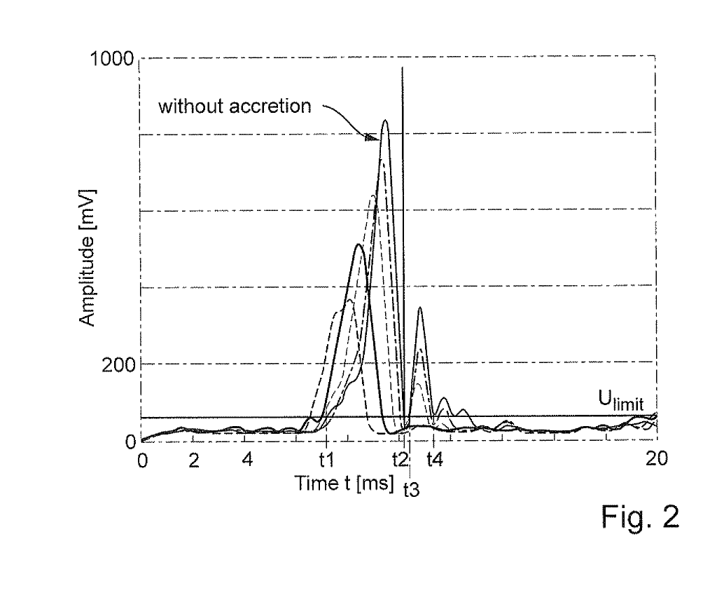

FIG. 2 the phase weighted and lowpass filtered, received signal in the case of different amounts of accretion.

FIG. 1 shows the received recorded with a membrane oscillator signal in the case of exciting of the membrane with a frequency sweep. Additionally, a phase selective signal is presented. This is obtained when the received signal is sampled only at certain points in time for ascertaining an oscillation frequency, at which a predetermined phase shift is present between transmission signal and received signal, wherein the certain points in time are so selected that, when the predetermined phase shift Δφ is present between transmission signal and received signal, the extrema and/or zero intercepts in the received signal are detected and suitably evaluated. As can be seen, modulations occur both in the unchanged received signal as well as also in the phase selective signal. The presence in both signals means that the predetermined phase shift Δφ occurs also during the modulations.

The modulations come about through the superpositioning of various frequencies. A superpositioning of the frequencies is possible, in spite of the discrete exciting, since the oscillations do not immediately end after the exciting, but, instead, decrease exponentially, so that, for a certain time, oscillatory energy is stored. As a function of the current phase shift, the oscillations strengthen or weaken. Maxima in the phase selective signal and, respectively, in the received signal occur when the decaying oscillation and the newly excited oscillation suitably superimpose. Thus, the predetermined phase shift Δφ is fulfilled not only for the frequency to be ascertained, in the case of which the global maximum occurs, but, instead also in the case of following frequencies. The amplitude during the modulations is, however, smaller, so that the frequency to be determined by the frequency sweep is unequivocally established. The exponential decline of the resonant oscillation is clearly recognizable in the form of the envelope of the received signal.

FIG. 2 illustrates the effect of accretion on the phase selective, received signal in the case of a frequency sweep for ascertaining the frequency, at which a predetermined phase shift Δφ is present between transmission signal and received signal. Shown are the phase selective signals received after a low-pass filtering in the case of a membrane oscillator without accretion and with four different accretion amounts recorded over a period of time of 20 ms. The larger the mass of the accretion, the lower is the amplitude of the phase selective, received signal. The shown curves were recorded with accretion amounts of 100, 200, 300 and 400 mg, which corresponds, for instance, to 1-4% of the membrane mass. The global maximum is weakened, but is, in all cases, clearly detectable. The local maxima, in contrast, are, due to the fast decaying of the oscillation, already limited in their occurrence, so that their number decreases and, for larger accretion amounts, there are no local maxima.

In the following, two preferred methods for detection of accretion will now be described. The choice of method depends firstly on how the oscillatable unit is excited for determining the process variable. In principle is, however, any combination of excitation- and evaluation methods is possible.

In the case of a first method for accretion detection, the decay behavior of the received signal following on the exciting of the oscillatable unit with the frequency, at which a predetermined phase shift Δφ is present between the transmission signal and the received signal, is evaluated by determining the decay constant.

In case the exciting occurs with a phase shift Δφ fixed via an oscillatory circuit and no frequency sweep is performed, the exciting of the oscillatable unit is interrupted for a short time. In the case the exciting is via a frequency sweep, an interruption of the excitation is not necessary, since the in any event recorded, received signal for frequency determination can also be used for evaluation with reference to accretion. At the exciting at the predetermined phase shift Δφ, energy is stored in the oscillatable unit, so that it continues to oscillate after the excitation for a certain time, wherein the amplitude f(t) of the oscillation decreases with time t according to an exponential function:

f(t)=A·e^{-αt}

In such case, A is a scaling constant and α the so called decay constant, which gives how strongly the exponential function declines. For the case, in which the oscillatable unit was excited with the resonance frequency, an especially large amount of kinetic energy is present in the oscillatable unit, so that the time period over which the oscillation continues, is correspondingly long. The decay constant a depends on the damping of the oscillating system. If damping accretion has formed on the oscillatable unit, the amplitude of the oscillation declines more strongly than without accretion. If the decay constant α0 for the oscillatable unit in the accretion free state is known, for example, through measuring at start-up of the measuring device, through comparison of the decay constant α determined during measurement operation with the beginning decay constant α0, it can be decided, whether accretion has formed.

In an alternative evaluating method, the accretion detection occurs via evaluation of modulations in the amplitude of the received signal, which in a frequency sweep follow, in time, the global maximum at the exciter frequency to be ascertained by the frequency sweep. Preferably, the evaluation according to the occurs in the manner described in the yet unpublished patent application (Application No. DE 10 2009 028022), by means of which the modulations can be better isolated from the noise. The global maximum is preferably established by a temporary exceeding of a predetermined threshold Ulimit, wherein the beginning of the global maximum is established by the point in time t1, at which the threshold Ulimit is exceeded for the first time, and the end of the global maximum is fixed by the point in time t2, at which the threshold Ulimit is crossed for the second time, however, in the opposite direction.

Correspondingly, the first local maximum is defined by the points in time t3 and t4, at which the threshold Ulimit is crossed the third and fourth times, etc. The threshold Ulimit is established, in such case, in such a manner that it always lies above the noise floor of the received signal. The points in time marked in FIG. 2 relate to the curve, which was recorded without accretion on the oscillatable unit.

For evaluation of the modulations, two methods are especially advantageous. These will now be described as follows.

In the first method, the number of arising local maxima is determined and compared with the number determined for a received signal of a definitely accretion free oscillatable unit. Preferably, this reference measurement is done at start-up of the measuring device or already in the factory. In the case of a measuring device, which is applied for monitoring a maximal fill level, a reference measurement by the manufacturer is especially suitable, since the reference measurement can occur in air and, consequently, be performed independently of the fill medium. Alternatively, instead of the exact number of local maxima, it can be determined, whether local maxima are present or not. If none are present, with great probability, a dangerous amount of accretion has formed and an alarm signal is output or a warning transmitted to a control room.

In an alternative method for evaluation of the modulations, the variance of the measured values is determined after the occurrence of the global maximum, thus for all measured values recorded after the time t2. The variance gives the deviation of a measured value from the average value. The smaller the variance is, the smoother is the curve and the less maxima and minima occur. A low variance is, consequently, associated with a disappearance of the modulations and, thus, with accretion formation.

### List of Reference Characters

t1 point in time, at which the global maximum begins
t2 point in time, at which the global maximum ends
t3 point in time, at which the first local maximum begins
t4 point in time, at which the first local maximum ends
Ulimit voltage value, which must be exceeded by the received signal, in order that a maximum be recognized

1-15. (canceled)

16. A method for determining and/or monitoring at least one physical, process variable of a medium with an oscillatable unit, comprising the steps of:
exciting an oscillatable unit to execute oscillations with a transmitting/receiving unit by means of transmission signals, wherein the oscillations of the oscillatable unit are received in the form of received signals;
determining the process variable and/or monitored based on the frequency and/or the amplitude of the received signal and/or the phase shift between the transmission signal and the received signal;
examining the time behavior of the amplitude of the received signal and evaluated as a function of a time variation of the exciting of the oscillatable unit; and
determining therefrom whether accretion has formed on the oscillatable unit.

17. The method as claimed in claim 16, wherein:
the oscillatable unit is excited by means of a frequency sweep within a predetermined frequency band in the working range of the oscillatable unit by means of transmission signals successively to execute oscillations with discrete exciter frequencies following one after the other;
the oscillatable unit has a resonance frequency fRES;
at least one of the exciter frequencies lies within a narrow interval around the resonance frequency fRES, and the received signal is evaluated relative to modulations, which occur in the form of local maxima and minima in the received signal;
local maxima of the received signal are detected, which occur when the decaying oscillation with the exciter frequency lying in the narrow interval around the resonance frequency fRES superimposes constructively with oscillations at frequencies following in the sweep; and
as a function of the number and/or height of the detected local maxima, it is detected, whether accretion has formed on the oscillatable unit.

18. The method as claimed in claim 17, wherein:
there is ascertained by the sweep an oscillation frequency, at which a predetermined phase shift hap is present between the transmission signal and the received signal.

19. The method as claimed in claim 18, further comprising the step of:
producing a phase selective signal from the received signal and the maxima of the phase selective signal are detected.

20. The method as claimed in claim 17, further comprising the steps of:
evaluating the received signal relative to the decay constant of the exponential function resulting from the type of excition; and
detecting, as a function of the change of the decay constant over a defined period of time, whether accretion has formed on the oscillatable unit.

21. The method as claimed in claim 17, further comprising the step of:
establishing a threshold Ulimit of the received signal or of the phase selective signal, which is exceeded by a global maximum at a point in time t1 and subceeded at a later point in time t2, wherein:
the global maximum occurs at a frequency, which lies within the narrow interval around the resonance frequency fRES, and/or in the case of which the predetermined phase shift Δφ is present; and
the point in time t2 of the subceeding of the threshold Ulimit establishes the end of the global maximum.

22. The method as claimed in claim 21, wherein:
the number of local maxima arising in the received signal or in the phase selective signal is determined, wherein a local maximum is defined by the feature that the threshold Ulimit is exceeded at a point in time t3 lying behind the point in time t2, which determines the end of the global maximum, and subceeded at a later point in time t4, a minimum number of local maxima is established, which must be present, when the oscillatable unit has no accretion and, through comparison of the arising number of local maxima with the minimum number, it is determined, whether accretion has formed on the oscillatable unit.

23. The method as claimed in claim 21, wherein:
the variance of the voltage values of the received signal or of the phase selective signal, which lie behind the point in time t2, which determines the end of the global maximum, is ascertained, a threshold value for the variance is fixed, which is at least reached, when the oscillatable unit is free of accretion, and by comparison of the value determined for the variance with the threshold value, it is determined, whether accretion has formed on the oscillatable unit.

24. The method as claimed in claim 16, wherein:
the oscillatable unit has a resonance frequency fRES, the exciting of the oscillatable unit is done with a frequency lying in a narrow interval around the resonance frequency fRES or with a frequency, at which a predetermined phase shift Δφ is present between transmission signal and received signal, the exciting for a short time is interrupted, the received signal is evaluated relative to the decay constant of the exponential function resulting from the interruption of the exciting, and, as a function of the decay constant, it is detected, whether accretion has formed on the oscillatable unit.

25. The method as claimed in claim 18, wherein:
the predetermined phase shift amounts to 90°.

26. The method as claimed in claim 16, wherein:
in case accretion has formed, an error report is produced and output and/or displayed.

27. The method as claimed in claim 17, wherein:
a number of limit values are predetermined for the number of local maxima or the variance, through comparison with the ascertained number of arising local maxima or with the ascertained variance, it is determined, how strongly the oscillatable unit is covered by accretion and a corresponding error report is produced and output and/or displayed.

28. The method as claimed in claim 16, wherein:
the time behavior of the amplitude of the received signal or of the phase selective signal is evaluated in the case of oscillation of the oscillatable unit in air.

29. The method as claimed in claim 16, wherein:
the time behavior of the amplitude of the received signal or of the phase selective signal is evaluated in the case of oscillation of the oscillatable unit in the medium and, for this, a calibration measurement is done in the medium, in which behavior without accretion on the oscillatable unit is determined.

30. The method as claimed in claim 16, wherein:
the oscillatable unit is one of: a membrane, a membrane with an oscillatory fork or an oscillatory rod.
